(19) United States
(12) Patent Application Publication
(10) Pub. No.: US 2016/0177480 A1
(43) Pub. Date: Jun. 23, 2016

(54) Building Material with Woven Fabric and Methods of Making the Same

(71) Applicant: Cady Bag Company, LLC, Pearson, GA (US)

(72) Inventors: Alonza Paulk Cady, Pearson, GA (US); Samuel Jared Watson, Denver, CO (US); Douglas Baird Smith, Tifton, GA (US)

(73) Assignee: Cady Bag Company, LLC, Pearson, GA (US)

(21) Appl. No.: 14/581,942

(22) Filed: Dec. 23, 2014

(51) Int. Cl. D03D 19/00; B32B 27/32; B32B 27/06; E04D 5/08; B32B 5/02

(52) U.S. Cl. CPC D03D 19/00; E04D 5/08; B32B 5/024; B32B 27/06; B32B 27/32; B32B 2419/00

(57) ABSTRACT

A sheet building material used in construction has a woven fabric structural component including a portion with a leno weave providing an aggressive surface grip. The woven fabric is combined with structural features including tight weaves and loose weaves for implementation as a roof underlayment that maintains structural integrity. The building material optionally includes a non-woven material, a substrate such as biaxially oriented polypropylene, or additional woven structural components.

### FIELD OF THE INVENTION

The present invention is related to sheet building materials such as sheet material used as wraps and roof underlayment used in construction. In particular, the present invention is directed to an improved sheet material with a leno fabric structural element providing an aggressive surface grip.

### BACKGROUND OF THE INVENTION

There is usually at least one layer of protection between a roofing material and the roof frame comprising a roofing underlayment. In one of the most common practices, the underlayment comprises a sheet material that is attached to the roof deck and helps to attach the roofing material to the deck and also provides other advantages, such as improved strength, reinforcement, cushioning for the roof material and insulation.

There are many options for roofing underlayment materials including rubberized asphalt, organic materials, fiberglass, and synthetic materials. Asphalt underlayments are presently becoming less popular in favor of modern sheet materials that are often engineered composites in combinations and technical features to improve the properties in comparison to traditional asphalt. For example, many of these modern engineered sheet materials for roof underlayment use have anti-slip technology to protect the people who install the roof, as the underlayment can be exposed for up to six months while the roof gets built.

As the roof is installed, the underlayment helps the roof material or shingles comprising the final roof covering to lay flatter and prevent buckling, which helps to prevent blow-off of the roof covering material by wind. Once the roof is installed, the underlayment provides other protection between the roof material and the roof deck. For example, the underlayment acts as a weather barrier and helps prevent wind-driven rain or water from other sources from infiltrating under the shingles and causing damage to the roof structure or the inside of a building. With traditional shingles, the roofing underlayment protects all of the seams between the roof frame and the roofing material.

Roof underlayment should preferably reduce the chances for moisture and mold by allowing water vapor to escape from inside a building. Noxious gases should also be able to escape. For these reasons, many roof underlayment sheet materials are engineered to be breathable, while still being sufficient to prevent rain and wind damage and have adequate physical properties to prevent tearing, elongating, shrinking, breaking, or puncturing. The underlayment material must also remain durable for the expected life of the roof.

Recently, underlayment sheets comprising fabrics and polymer films have been devised and introduced to the roofing industry to overcome shortcomings of traditional asphalt underlayment. Such composite materials may be substantially lighter and longer-lasting. However, an ongoing need exists for these materials to be strong and affordable for low-end applications. Low-end applications, such as traditional single-family homes, are sometimes too cost sensitive to take advantage of the modern underlayment that are favorably engineering with respect to features, but more expensive to the consumer. Another ongoing need is for the modern underlayment material to be slip resistant while wet during that time that the underlayment is exposed during roof installation. The combination of being both technologically advances to provide slip resistance during installation while being affordable remains a challenge in the industry.

U.S. Pat. No. 8,091,310 to Jones et al. provides one example of a modern building material used as underlayment. Jones uses fabric strands of varying thickness combined with polymer film bonded together. The multilayer material provided by Jones is believed suitable for high-end uses but less flexible and suitable for low-end uses because of the complexity of requiring different thickness strands and a bonded polymer film layer.

Accordingly, an ongoing need exists for a modern building material for use as an underlayment that is lightweight, strong and provides anti-slip technology, while remaining affordable and flexible enough to be used in a variety of low-end and high-end applications.

### SUMMARY OF THE INVENTION

The invention provides an improved sheet building material with woven leno fabric and methods of making the same. The improved material is manufactured in the form of a sheet material that is particularly useful as a roof underlayment material.

A first object of the invention is to use a leno weave in a building material to create a coarse or grated surface on the sheet material with an aggressive grip that gives a secure surface for a roofer to stand on during installation of a roof material after installation of the roof underlayment.

Another object is to create a surface on the building material that provides grip or antiskid properties even when wet or having water pouring over the surface of the material.

Another object is to provide a material with aggressive grip that is inexpensive to manufacture, while still being modern and lightweight and being suitable as a roof underlayment that gives grip to a roofer's shoes.

Another object of the invention is to provide a building material having a surface on at least one side thereof that can be installed with aggressive grip for a roofer to stand on, while the building material can also be combined with substrates that provide further improved properties.

Yet another object is to provide a building material particular useful as a roof underlayment with aggressive grip that can be woven in combination with a flat fabric.

Still another object is to provide a building material that improves grip on a surface of the material while also reinforcing and strengthening the structure of the material, whereby the material provides an excellent roof underlayment.

Another object is to provide a material that improves grip without need for a supplemental coating layer, special polymers, or high tensile strength carrier substances that increase the cost of manufacturing in order to maintain a building material that is suitable for cost sensitive applications such as single family housing.

Another object is to create a building material having a stable surface for use as a roof underlayment material by weaving a combination of flat weave and leno weave on the same fabric.

Another object of the invention and embodiments discussed herein is to provide a high end underlayment material with a leno weave material laminated to a flat fabric.

Another object is to provide an underlayment material for application to wood surfaces on a roof by laminating woven leno fabric to a non woven material suitable for attachment to a wood surface, while maintaining a surface on the material that provides an aggressive grip for the roofer.

Another object is to provide dimensional stability for building material comprised of a leno fabric and used in roof underlayment by including attachment of various films to the leno fabric such as biaxially oriented polypropylene (BOPP) film.

Another object of the invention is to provide a four layer roof underlayment material structure including a laminate of leno fabric and nonwoven material combined with a BOPP film using a heat seal layer.

Yet another advantage is to provide a building material used in roof underlayment with an aggressive grip that does not require bonded intersections points of a fabric and, therefore, can be manufactured at less expense.

And, still another object of the invention is to provide a building material used in roof underlayment having a surface with an aggressive grip using flat, thin and light tape yarns that minimize weight and thickness.

Further advantages and features of the building material with woven fabric and methods of making the same are explained in more detail in connection with the examples provided in the drawings.

### BRIEF DESCRIPTION OF THE DRAWINGS

FIG. 1 is a perspective view of the building material with leno weave of the present invention applied to a roof of a building as a roof underlayment.

FIG. 2 is a top plan view of an exemplary embodiment of a building material with leno weave in accordance with an embodiment of the invention.

FIG. 3 is an enlarged top plan view of the building material in FIG. 2.

FIG. 4 is sectional cut-away view of the building material along line 3 of FIG. 3 showing the lift caused by the twist of the weave.

FIG. 5 is an enlarged top view of a section of the building material illustrating the leno weave in more detail.

### DETAILED DESCRIPTION OF THE DRAWINGS

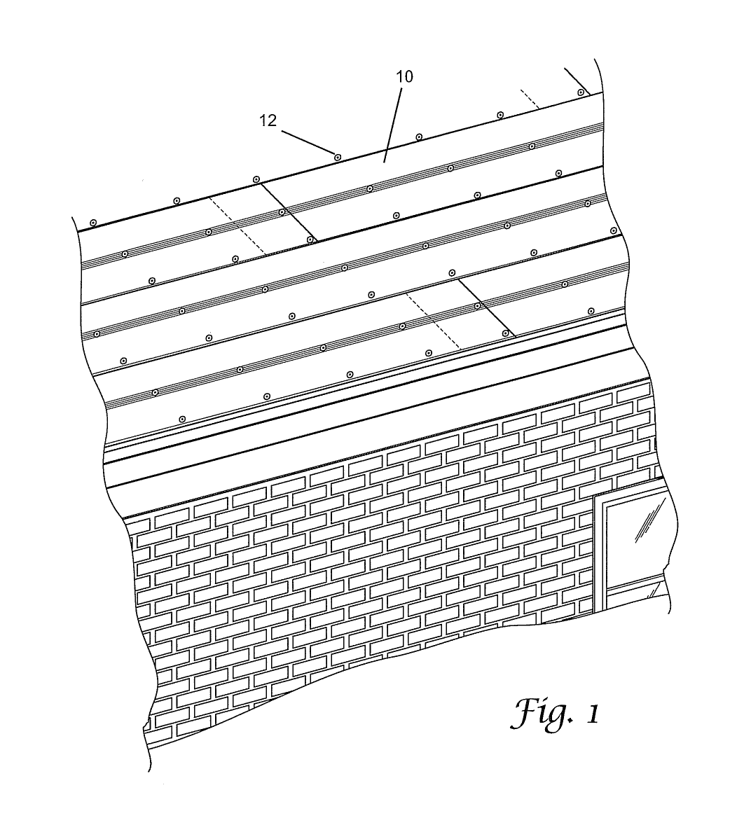

Referring now to FIG. 1 a preferred example embodiment of the invention is disclosed. FIG. 1 shows a sheet building material 10 installed on a roof of a building as a roofing underlayment material. The building material is attached using a desired means, such as roofing nails 12. In a typical installation for the strong, lightweight and inexpensive material provided by the exemplary embodiment, the building material 10 will function as a roof underlayment and will be attached to a wood substrate on a residential building. After installation, the building material 10 shown in FIG. 1 will be covered by a roofing material such as asphalt shingles, metal roofing or the like. During installation of the roofing material, the underlayment provided by the building material 10 herein will provide a coarse surface for the roofer to walk on by providing an aggressive grip. The building material 10 provides the grip while dry or when wet, raining or covered in water.

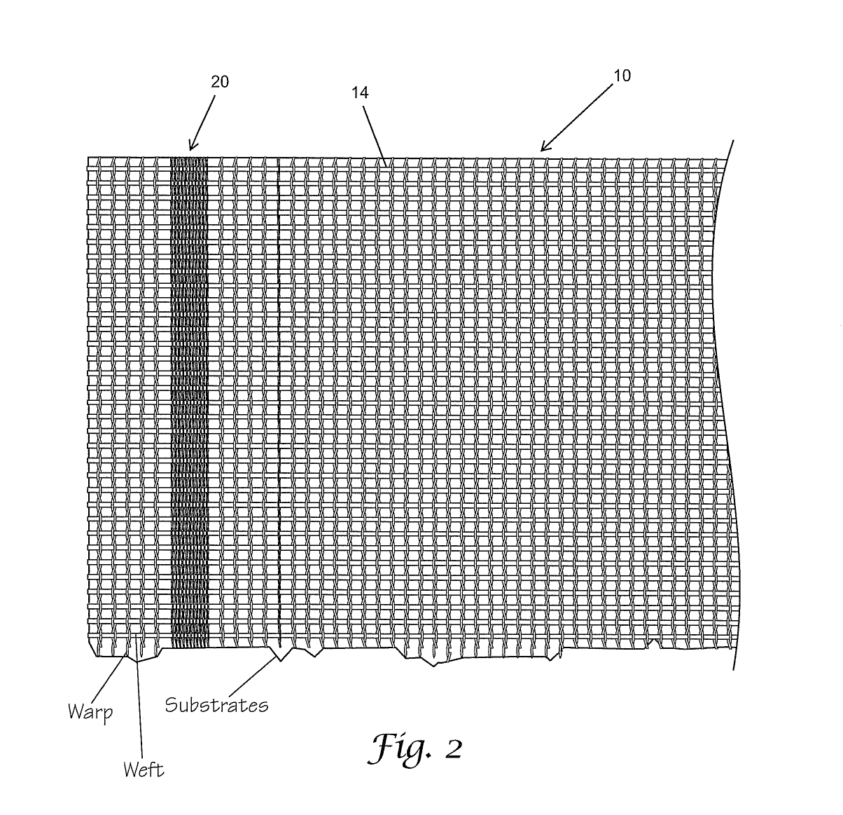

FIG. 2 shows the sheet building material 10 in the embodiment of FIG. 1 in more detail. The building material includes a fabric comprising a typical flat weft yarn 14 or thread providing transverse structure for the fabric of the building material. The fabric of the building material 10 further includes at least some portions with a leno weave, which may alternate with portions without the leno weave. In the leno weave portions, each lengthwise thread includes two warp yarns or threads that provide a lengthwise or longitudinal thread of the material. These warp yarns may be referred to as the doup warp yarn 16 and the ground warp yarn 18. The two warp yarns are twisted around the weft yarns 14 to provide leno weave. The leno warp yarns 16, 18 bind at least respectively one doup warp yarn 16 inserted onto the ground warp yarns 18 together with the ground warp yarns, whereby the leno warp yarns are adjusted to a warp tension that is suitable for the fabric of the building material.

The leno weave provides a strong and durable fabric. However, the material is strengthened further using a combination of a light leno weave of FIG. 2 in combination with a reinforced area 20 of weave that provides tear resistance strips. The leno weave provides aggressive grip for the surface of the building material, while the tighter weave of the reinforced area 20 with additional warp yarns 16, 18 increases strength and provides a buffer against tearing of the building material. The reinforced weave of the tear resistant strips may still use a leno weave for substantial grip, but improve the economy of manufacturing the building material by providing a lighter overall weave with less yarn being required through the remainder of the building material 10.

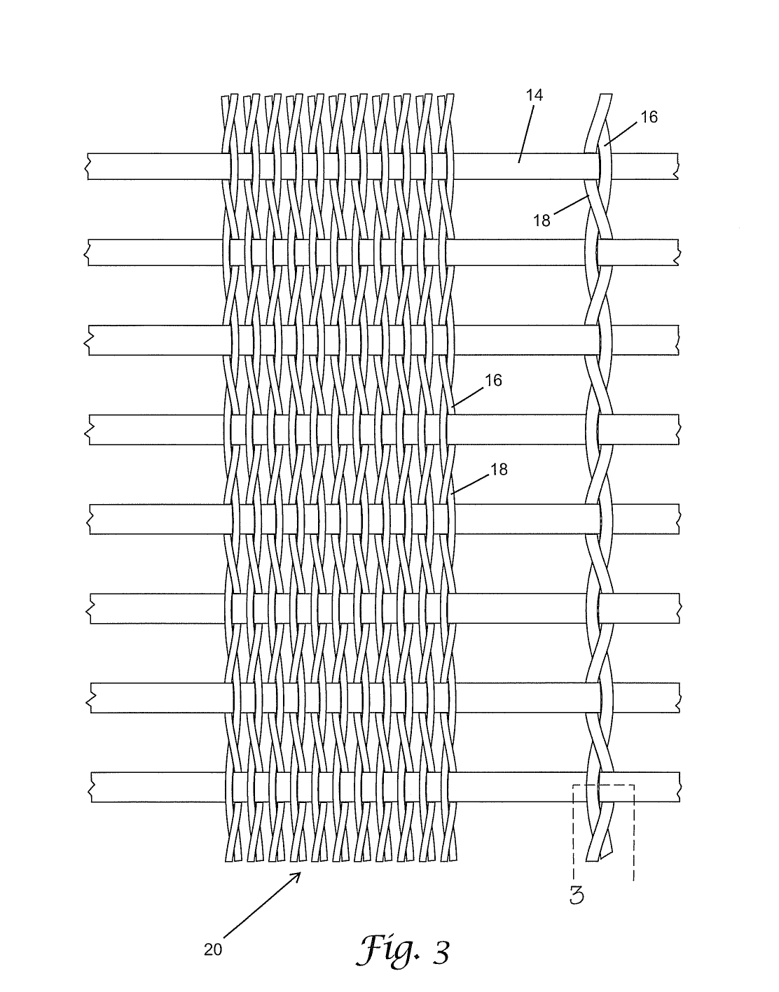

In FIG. 3 both the reinforced area 20 of the material and the lighter leno woven area of the building material are enlarged for clarity. As seen in the illustration, the leno weave is threaded with a pair of leno warp yarns 16, 18 with one yarn crossed over the other. The doup warp yarn 16 of the pair is drawn across to the left as one heddle is raised and then back to the right when the other heddle is raised to crisscross the pair of leno warp yarns. The crisscrossed leno warp yarns cause a first warp yarn, the doup warp yarn 16, to twist even when the pair of leno warp yarns has similar or lesser weight and strength compared to the weft yarn 14. The weft yarn is woven in, and for each weft shuttle the pair of leno warp yarns is twisted interchangeably to produce a figure of eight pattern.

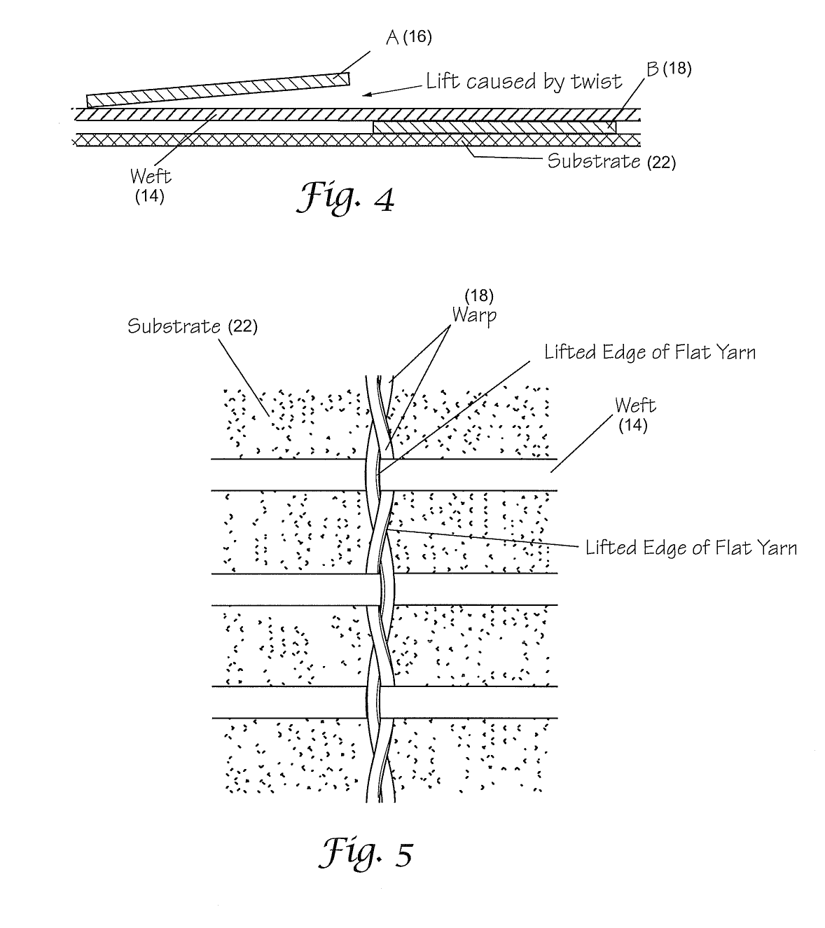

FIG. 4 shows a cross-section of the building material 10 of FIG. 3 along line-3. As illustrated the first warp yarn “A” or doup warp yarn 16 is twisted during the crisscross process, which causes the right hand edge of the first warp yarn to lift away from the weft yarn 14 at an angle. The right-hand edge of the first warp yarn “A” is exposed above the upward surface of the building material. The combination of the upward angle, the exposed edge, and the thin profile of the yarn's edge creates an aggressive grip. The grip of a single leno warp is duplicated in the building material 10 by the leno weave existing across the surface of the building material.

In the exemplary construction of the fabric portion of the building material 10, there are 4.8 yarns per inch woven in the warp direction of the fabric. Meanwhile, there are 3 yarns per inch woven in the fill direction. Experimentation has determined that a warp yarn of 650 denier, or 1.8×73 mil in dimension, provides the features and benefits desirable for the leno weave of the fabric of the building material 10. The 650 denier warp yarn is woven with a similar dimension fill yarn such as 1050 denier, or 1.75×108 mil. The embodiment's fabric weight is about 0.81 ounce per square yard. The overall thickness and weight of the yarns are in both directions are nearly the same, preferably within 3% of each other, i.e. 1.8×73 mil warp versus 1.75×108 mil fill. This permits utilization of flat yarns and eliminates the requirement for yarns of significantly different thickness and eliminates any need for round yarn or monofilament in order to obtain the aggressive grip provided by the fabric of the building material 10.

As illustrated in FIG. 2 and further in FIGS. 4-5, the woven fabric material of the building material may be applied to a substrate 22. The substrate may comprise materials to improve the strength of the building material or material to enhance physical qualities for particular applications. As detailed in an exemplary embodiment in FIGS. 4-5, the leno fabric building material 10 is situated on top of the substrate 22, whereby the grip of the leno fabric building material is maintained. Adding the leno fabric building material 10 to the non-woven substrate 22 can provide an underlayment material for application to wood surfaces on a roof. The woven leno fabric building material 10 can be laminated to a nonwoven material suitable for attachment to a wood surface by nails, staples, glue or other attachment means.

An exemplary substrate 22 for application to the building material 10 having a woven fabric herein is biaxially oriented polypropylene, known as BOPP. This polypropylene film is extruded and stretched in both the machine direction and across machine direction, which increases strength and clarity. BOPP works synergistically with the fabric material of the building material 10 because it can provide a smooth surface on one side of the building material that is useful for installation of the material as a roofing underlayment on wood. Further, BOPP does not add dramatically to the cost and labor involved in manufacture because BOPP is easy laminate onto the fabric material. Distributors or consumers also appreciate and sometimes desire building materials that are printed or coated for special applications or for branding. BOPP is easy to convert and to coat with other materials or to print on the surface provided thereby to give the required appearance and properties desired.

The substrate 22 is not limited to BOPP. Another desirable embodiment includes providing the leno weave fabric portion of the building material 10 in combination with a flat fabric as a substitute substrate material. There are alternative means for accomplishing this combination. In a first embodiment, the leno weave is mixed into the same fabric with a flat fabric weave by varying the weave of the sheet of fabric therein. For example, the woven fabric of the building material 10 may include alternating strips of leno weave and flat weave. This could be useful in reducing cost by varying materials or yarns, creating patterns or changing properties of the building material.

In a second embodiment, the leno weave building material 10 is laminated to a flat fabric material that substitutes for the substrate 22. In this embodiment the flat fabric provides a backing for the leno weave without reducing the aggressive grip providing by the leno material on the opposing side of the building material. The flat fabric can provide strength and reinforcement while maintaining the aggressive grip property of the leno weave of the building material 10. The flat fabric substrate 22 can also improve the bottom surface of the sheet material for installation on a roof deck by allowing the substrate attached to the building material to make consistent contact with the roof deck and remain flush, which is useful for certain wood decks and other applications.

The building material 10 combined with a substrate material can inexpensively provide a reinforced roof underlayment comprising four layers. A first layer of the underlayment comprises the flat weft yarns of the building material, while a second layer of the underlayment comprises the warp yarns. At least portions of the warp yarns are manufactured to the underlayment second layer having a leno weave. A third layer of the underlayment comprises a nonwoven material, or substrate, laminated to the first two layers of the woven fabric material, and a fourth layer of the underlayment may comprise a BOPP film, as an addition to the substrate, covering the woven fabric material of the first two layers as a heat seal layer. Alternative, depending on the purpose of the construction and the materials used, the fourth layer may comprise a heat seal layer or other material combined with the nonwoven material of the laminate layer through further lamination of other reinforcement means.

Other modern woven roof underlayment materials have improved grip of a surface by bonding intersection of the material to create lift. An advantage discovered in the solution of the present invention is that the building material 10 provides an aggressive grip that does not require bonded intersections points of a fabric and, therefore, can be manufactured at less expense. The leno weave fabric design is found to maintain structural stability after manufacture as a building material while retaining the raised course surface that provides grip. As a further advantage, the building material 10 is manufactured using standard yarns, further reducing costs. Rather than use varied yarns or exotic and expensive large yarns combined with thin yarns, the present building material can be manufactured using flat, thin and light tape yarns that minimize weight and thickness.

A number of implementations have been described. Nevertheless, it will be understood that various modifications may be made. For example, features of one or more implementations may be combined, deleted, modified, or supplemented to form further implementations. As yet another example, the substrates or leno woven fabric depicted in the figures do not require the particular order or structure shown to achieve desirable results. In addition, other steps may be provided, or steps may be eliminated, from the described methods for manufacturing the building material, and other components or substrates may be added to, or removed from, the described building material. Accordingly, other implementations are within the scope of the claims.

We claim:

1. A sheet building material used in construction comprising:
a woven fabric structural component including a leno weave;
the leno weave includes warp threads, each having a doup warp yarn and a ground warp yarn, and includes a weft yarn that the doup yarn and ground warp yarn each crisscross;
the doup yarn of each warp thread is lifted by the crisscross and provides an upward angle with an exposed edge, whereby the doup yarn's edge provides a course surface for the sheet building material after installation on a roof.

2. A sheet building material as in claim 1 in which the leno weave includes several spatially separated portions of leno weave separated and alternating with portions of the structural component that do not have a leno weave.

3. A sheet building material as in claim 1 in which the woven fabric structural component includes the leno weave that comprises a loose leno weave in combination with more tightly woven reinforced areas of woven fabric that provide tear resistance strips.

4. A sheet building material as in claim 3 in which the more tightly woven reinforced areas of woven fabric consist of leno weave.

5. A sheet building material as in claim 1 including a non-woven material as a substrate supporting the woven fabric structural component.

6. A sheet building material as in claim 5 in which the substrate comprises biaxially oriented polypropylene.

7. A sheet building material as in claim 1 including a flat-fabric material as a substrate supporting the woven fabric structural component by lamination of the woven fabric structural component to the flat-fabric material.

8. A sheet building material as in claim 1 in which 4.8 yarns per inch are woven in a warp direction of the woven fabric structural component and 3 yarns per inch are woven in a fill direction of the woven fabric structural component.

9. A sheet building material as in claim 1 in which the doup warp yarns and ground warp yarns have a weight of 650 denier.

10. A sheet building material as in claim 9 in which the weft yarns have a weight of 1050 denier.

11. A sheet building material as in claim 1 in which the doup warp yarns and ground warps yarns have a thickness less than the thickness of the weft yarns and the thickness of the warp yarns is within 3 percent or less of the thickness of the weft yarns.

12. A sheet building material used in construction comprising a woven fabric structural component including a leno weave, the leno weave including warp threads, each warp thread having a doup warp yarn and a ground warp yarn having a weight of 650 denier, and includes a weft yarn that the doup yarn and ground warp yarn each crisscross, each weft yarn having a weight of 1050 denier, and said woven fabric structural component is laminated on a first side with a substrate comprising biaxially oriented polypropylene, and the woven fabric structural component has a second side with course surface having aggressive gripping properties provided by an exposed and lifted edge of the doup warp yarn.

13. A sheet building material used in construction comprising four separate layers including a first layer comprising flat weft yarns, a second layer comprising warp yarns woven with the first layer of flat weft yarns in which at least a portion of the second layer of warp yarns have a leno weave, a third layer comprising a nonwoven substrate laminated to the first layer and the second layer, and a fourth layer comprising a biaxially oriented polypropylene that seals and covers a woven fabric material comprising the first and second layers.
